(19) United States
(12) Patent Application Publication
(10) Pub. No.: US 2019/0318317 A1
(43) Pub. Date: Oct. 17, 2019

(54) Universal Position Model Assisted Staffing Platform

(71) Applicant: PRO Unlimited Global Solutions, Inc., Boca Raton, FL (US)

(72) Inventors: Ted Sergott, Moraga, CA (US); Nataliya Kolb, San Francisco, CA (US); Haihua Huang, Cupertino, CA (US)

(21) Appl. No.: 16/382,116

(22) Filed: Apr. 11, 2019

Related U.S. Application Data
(60) Provisional application No. 62/656,881, filed on Apr. 12, 2018.

(51) Int. Cl. G06Q 10/10; G06Q 10/04

(52) U.S. Cl. CPC G06Q 10/1053; G06Q 10/04

(57) ABSTRACT

The present invention is directed to systems and methods for providing job searching services, recruitment services and/or recruitment-related services. In particular, this invention relates to systems and methods for identifying job candidates and predicting performance of those candidates. In particular, this invention relates to systems and methods for providing a UPM assisted staffing platform leveraging machine learning to provide mobile-based and web-based information in real-time. The present invention comprises a UPM assisted staffing platform that matches the hard skills, soft skills, and compensation of candidates with pertinent job recruitment information in order to recommend recommends candidates to staffing suppliers.

### RELATED APPLICATIONS

The application claims priority from the United States provisional application with Ser. No. 62/656,881, which was filed on Apr. 12, 2018. The disclosure of that provisional application is incorporated herein as if set out in full.

### FIELD OF THE INVENTION

The present invention is directed to systems and methods for providing job searching services, recruitment services and/or recruitment-related services as they may relate to suppliers, hiring managers and/or hiring entities, in a network environment. In particular, this invention relates to systems and methods for identifying job candidates and predicting performance of those candidates.

### BACKGROUND

The goal of hiring is to find the best candidate for the position, or said differently, the ability to predict job performance. It can be burdensome and difficult to find candidates that match the desired and needed skills, compensation and culture of the employer. In many instances, employees may be hired for their hard skills, but later fired for their soft skills, attitude or mismatched culture fit. Hard skills (i.e., software coding competency) are those that are typically shown on a resume and are absolutely required for a given position. Soft skill information relates to personality, problem-solving ability, task switching ability, impulse control, response inhibition, and other skills that are difficult to quantify.

The challenge of matching suitable candidates with job openings available at a given time is ever-present. Recruiters, hiring managers and human resources personnel are often inundated with numerous job applicants or candidates for open positions. Particularly in times of economic stress where very large numbers of candidates may be seeking a small number of openings, the review process can tax even the most experienced human reviewer. During the screening process, qualified candidates may be erroneously removed from an initial pool of candidates due to human error. While hiring managers often intend to remove many candidates from such pools due to, for example, lack of cognitive ability, incompatible personality, ill temperament, or for other soft skill-related reasons, it is also a common occurrence that hiring managers and suppliers are inundated with hard data and have quantifying soft skill information. In addition, heterogeneity in soft skills within an existing employee pool may lead to disagreement as to which candidates have the most suitable soft skills for a given position.

Conversely, a candidate may find it extremely difficult to locate a truly suitable position for themselves both from hard skill and soft skill perspective. It is also becoming more common for employers to leave positions vacant rather than fill them with candidates whose potential personality mismatches may adulterate the entire employee pool with a domino-like effect. For such employers, it is critical to be presented quickly with candidates who should be invited to interview. As a consequence, the demand for low-cost and efficient automated means of matching suitable candidates with job openings has grown.

Computer automation of the process of matching candidates with particular openings has been attempted in the past. There prove to be a number of key limitations in existing methodologies, however, which mean that the most suitable candidates are often overlooked when trying to fill a given position. An example of one attempt at automation is described in Yi et al (J. A. Xing Yi, and W. B. Croft. “Matching resumes and jobs based on relevance models”, in SIGIR 2007 Proceedings, page 809, July 2007). In that study the authors attempted to accomplish automated resume job matching utilizing Monster.com's database (see, e.g., www.monster.com/). The relevance models were based on actions taken by a recruiter that might be inferred as an implicit judgment about the likelihood of a resume-job match. The authors found that implicit feedback was insufficient to yield reliable results.

One key to the successful utilization of candidate, supplier and hiring company data is to recognize the wide variety of information that is now made available. Achieving new methods of analyzing said data, automating access to said data, and the like, may facilitate the matching of candidates with job openings.

Therefore, one problem that has not been fully addressed is to properly ascertain a good set of features within both a candidate's resume and a description of a job opening that would lead to more reliable matching. Today's machine learning and neural networking algorithms can additionally, however, obtain relevant information about candidates that are not necessarily present in their resumes, but which is germane to the hiring process. This information comprises, in part, “soft skills” of job candidates such as personality and cognitive abilities.

One key to the successful utilization of soft skills and other non-obvious information is to recognize the new types of information that are now made available to inventors and software developers. In addition, it is vital that modern developers leverage the diverse software and hardware tools now available to them in order to analyze bulk data in a manner that is beneficial to the society and the economy, such as the challenge of matching candidates with job openings.

### SUMMARY OF THE DISCLOSURE

To minimize the limitations found in the existing systems and methods, and to minimize other limitations that will be apparent upon the reading of this specification, the preferred embodiment of the present invention provides methods and systems of providing mobile and web-based staffing assistance in a job recruitment context.

The present invention is directed to systems and methods of providing data-driven, client-specific, embedded intelligence to a user in real time. This invention addresses several problems that persists in the field: that staffing suppliers other hiring entities are often overwhelmed with hard skill information and suffer from a lack of quantifiable soft skill information. Further, the speed at which technology-savvy suppliers are able to manage staffing requests and schedule interviews is increasing every day.

Each of these issues may be facilitated by the present mobile and web-based system which leverages machine learning, personality survey, games, and other interactive functionalities to allow suppliers and other users to perform multiple actions. Such methods and systems facilitate identification of hidden candidate attributes such as hard skill, soft skill, and compensation attributes. In addition, such methods and systems facilitate identification and management of other candidate information, alternate employer locations, extraneous skills, external suppliers, new staffing requests, interview scheduling, and expense management.

The present invention relates to a software and hardware system called a Universal Position Model (referred to hereafter as “UPM”). UPM is an application that leverages machine learning and other tools in order to identifying the best candidates for a given position. In the preferred embodiment, UPM predicts the performance of those candidates by leveraging algorithms, machine learning, human input, games, surveys, and other tools in order to identify a neural assessment of candidates. The UPM assisted staffing platform forms a component of a VMS (Virtual Managed Services) system. The present invention comprises two components: the UPM and a staffing platform.

In the preferred embodiment, the herein disclosed methods for providing a Universal Position Model assisted staffing platform comprising: categorizing candidates with candidate assessments, receiving performance data with candidate skill information, analyzing candidate information from candidate assessments and/or performance data, applying predictive algorithms to analyzed candidate information, receiving new staffing requests from a user, displaying basic candidate information, wherein basic candidate information comprises heading information and candidate tally information; recommending one or more candidates to the users, wherein recommendations are based on analyzed candidate information and/or performance data; tracking activities of the candidates and the users; and providing updates to the candidates and the users, based on the tracking.

A first objective of the present invention is to provide a means to enhance job management efficiencies for users, staffing suppliers, hiring recruiters, hiring managers and other hiring entities.

A second objective of the present invention is to provide a means by which candidates can connect more efficiently with potential employers, through various media platforms.

A third objective of the present invention is to provide a means of focusing recruiter attention on securing interviews for candidates with the requisite skills required for a given job opportunity.

A fourth objective of the present invention is to provide a means for hiring entities and other users to match the hard skills from an applicant's resume with those well-defined skills required for a given job opportunity.

A fifth objective of the present invention is to provide a means for hiring entities and other users to match the soft skills for a given applicant such as personality and cognitive ability with the requirements for a given position.

A sixth objective of the present invention is to provide a means for hiring entities and other users to match the billing rates required by a candidate with those required by a given job opportunity.

These and other advantages and features of the present invention are described with specificity so as to make the present invention understandable to one of ordinary skill in the art. In addition, these and other features, aspects, and advantages of the present invention will become better understood with reference to the following description.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention. Thus the drawings are generalized in form in the interest of clarity and conciseness.

FIG. 1 is a diagram showing a system for identifying a job candidate and predicting the future performance of that candidate according to an embodiment;

FIG. 2 is a screenshot showing basic candidate information in addition to candidate tally information according to an embodiment of the invention;

FIG. 3 is a screenshot showing heading information in addition to basic candidate information according to an embodiment of the invention;

FIG. 4 is a screenshot showing basic candidate information and hard skill information according to an embodiment of the invention;

FIG. 5 is a screenshot showing soft skill competency information and a companion graphical image displaying weighted candidate scores according to an embodiment of the invention;

FIG. 6 is a screenshot showing candidate competency information, candidate strengths and weaknesses, and a resume conclusion section according to an embodiment of the invention;

FIG. 7 is a screenshot from a desktop program demonstrating the use of the Universal Position Model to suggest removal or reclassification of extraneous skills for a job opening according to an embodiment of the invention; and

FIG. 8 is a screenshot from a desktop program showing the use of a UPM assisted staffing platform to identify and recommend candidates according to a preferred embodiment of the invention.

### DETAILED DESCRIPTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term “about” means +/−5% of the recited parameter. All embodiments of any aspect of the invention can be used in combination, unless the context clearly dictates otherwise.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

The present invention, referred to herein as a UPM assisted staffing platform, is a staffing platform that matches candidates to jobs with levels of accuracy not possible under previous systems. UPM is an application that leverages machine learning and other tools in order to identifying the best candidates for a given position. In the preferred embodiment, UPM predicts the performance of candidates by leveraging algorithms, machine learning, human input, games, surveys, and other tools in order to identify a neural assessment of candidates. The current system builds a UPM for all positions in the world, with key input data comprising hard skills, billing rates, and soft skills.

AI & Intelligent Screening

In some embodiments, when choosing suppliers during the requisition creation process, the UPM assisted staffing platform may identify and recommend candidates from a internal and/or external database of candidates. The internal database of candidates is coupled with a UPM program that comprises a sourcing algorithm matching candidates to jobs with levels of accuracy not possible under previous systems. Candidate recommendations generated by the UPM algorithm are based primarily on an online candidate assessment (See Candidate Information section below). Particularly, the machine learning module may compare received information about the candidate, job requisition content, Talent Network information, candidate hard skill and soft skill information, and other contextual information in order to make automated candidate recommendations. Candidate information may include, for example, how closely a candidate's personality and background matches the job requirements compared to the average candidate using alternate external resources. The machine learning module may make this comparison using decision logic stored on the computer, or by other standard methods well known in the art.

Evaluating Soft Skills with Adaptive Tests and Games

While leading-edge vendors are already using algorithms to help evaluate hard skills and market rates, applying these tools to soft skills has remained elusive. But with the present invention, employing cutting-edge neural networks—computer systems modeled on the human brain and nervous system—in the form of tests and games can uncover these “hidden” personality attributes. These tests and games measure soft skills, such as logic problem-solving ability, risk taking ability, task switching ability, impulse control and response inhibition. al reasoning, problem-solving ability, risk-taking tendencies, impulse control and task switching. The best assessments are “adaptive,” providing deeper insights by getting progressively easier or harder depending on the individual's performance.

Building Models that Accurately Predict Performance

Leading-edge predictive technologies leverage these “gamified assessments” to help match candidates and jobs with more precision and less bias. To build these predictive models, an organization might have its top performers complete the assessments, and then use the results to identify traits shared by the best workers. Future job candidates would then complete the same tests, with proprietary algorithms combining with machine learning technologies to analyze the test results and predict future job performance with tremendous accuracy.

### Adjusting for Culture

Many organizations place heavy importance on cultural fit when evaluating candidates, while other companies are primarily interested in a candidate's skillset. In some cases, organizations may want to hire new candidates with the goal of changing their current culture. With this in mind, the best AI-powered predictive models can be customized to place more or less emphasis on cultural fit depending on client preference.

### AI Platform

Intelligent screening isn't the only [symbol] AI-related capability that the present invention leverages. Others include:

### Embedded Intelligence:

Within a manager's natural VMS workflow, they receive real-time, analytics-driven insights during the sourcing and hiring processes that drive better decision-making. This actionable intelligence can speed time to fill, increase cost savings and improve talent quality.

### Augmented Reality (AR):

Mobile apps use AR and the Internet of Things to help bring static objects, such as a campus building or employee handbook, to interactive life.

User Interface & Page Content

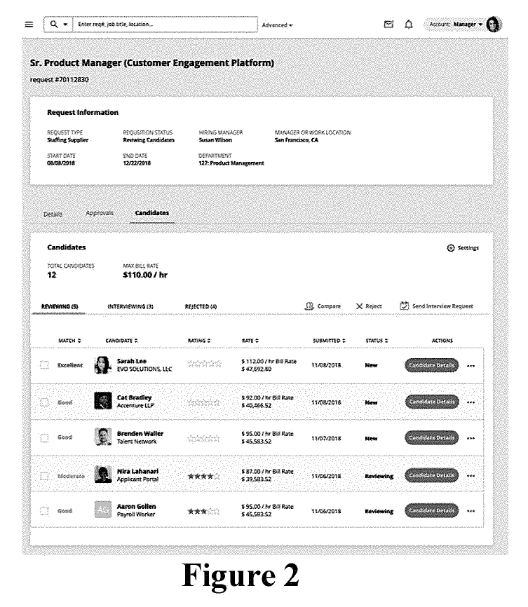

Referring to FIG. 2, basic candidate information including heading information and candidate tally information. As shown in FIG. 2, in some embodiments page heading information includes request type, requisition status, hiring manager, manager location, start date, and department information. As shown in FIG. 2, in some embodiments candidate tally information includes total number of candidates, max bill rate, number of candidates interviewing, number of candidates under review, number of candidates rejected, and candidates who have been sent an interview request. Further, candidates are assigned matching metrics including matching ratings comprising excellent, good, moderate match, and the like.

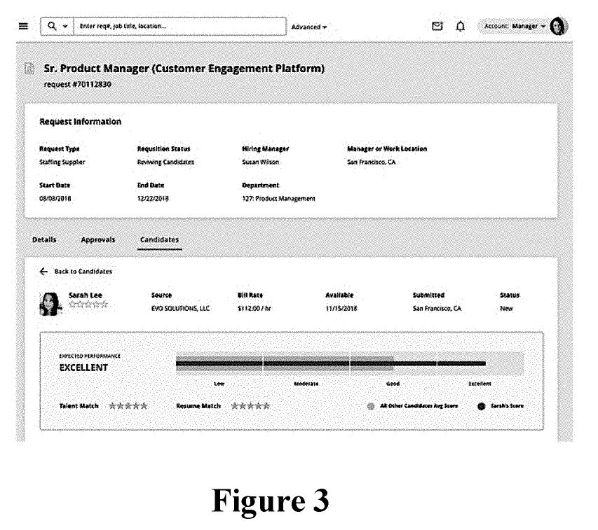

Referring to FIG. 3, in some embodiments the user interface includes additional basic candidate information including candidate detail and prediction information. Further referring to FIG. 3, in some embodiments candidate detail and prediction information comprises candidate profile picture, candidate recruitment source, availability date, date of submission, profile status (i.e., new or existing), and the like. In further reference to FIG. 3, candidate prediction information includes a ranking from “low” to “excellent” (i.e., with “moderate” to “good” intervening therein), in addition to a five star rating system relating to talent match and resume match criteria. In further reference to FIG. 3, in some embodiments a particular candidate's score may be overlaid with a visual indicator in relation to other candidate average scores.

Candidate Information

The present invention relates to systems and methods for analyzing candidate information for use by staffing suppliers in a job recruitment environment. Candidate information may include information required by employers and staffing suppliers, including hard skills, billing rates, soft skills, extraneous skills, salary expectations, hourly billable rates, geographic preferences, supplier interaction history, references, date of availability, interview information, and budget allocated to recruit a given candidate. Notably, the range of candidate information contemplated by the present application is very broad.

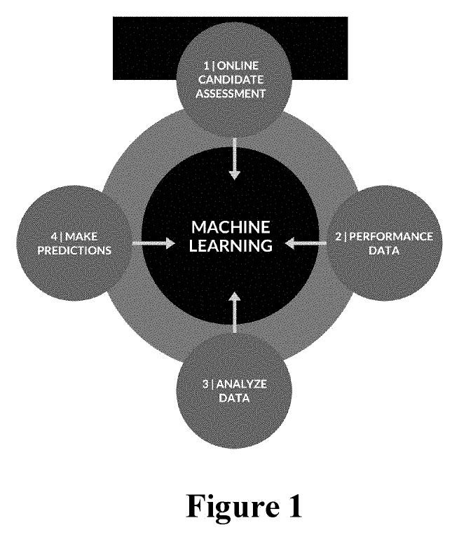

In some embodiments, candidate information comprises hard skills, billing rates, soft skills, extraneous skills, and other candidate information related to past interviews and employment history. Referring to FIG. 1, the machine learning functionality of the present invention receives hard skills and soft skill information inputs from online candidate assessments, performance data, data analysis, and a suite of predictive algorithms. Assessments and analysis related to hard skills and soft skills take a variety of forms ranging from a simple comparison algorithm to personality surveys and games that combine to uncover hidden attributes and ultimately compose neural assessments of the candidates and/or their traits.

Hard skills and hard skill information refers to quantifiable skills that are absolutely required for a given position. Hard skill information is traditionally listed on a resume and may derive from historical relationships such as prior employer, schools attended, subject areas of study, previous job titles, managerial qualifications, and other relationships commonly found across resume databases. On the other hand, soft skills derive from personality cognitive abilities and other information that is collected by adaptive personality surveys and games integrated into the present invention. said survey questions may change

I. Hard Skills

The UPM assisted staffing platform may identify and recommend candidates Based on hard skill information. As described above, hard skills can be matched algorithmically to job requirements, but the current disclosure further provides for a means of matching hard skills using machine learning, artificial intelligence, and embedded intelligence in order to further enhance the accuracy and precision of the staffing sourcing program.

In the preferred embodiment, hard skill information relates to skills that are absolutely required for a given position. Hard skill information may derive from historical relationships such as prior employers, schools attended, subject matter area(s) of study, previous job titles, managerial qualifications, and other information commonly mined in resume databases.

FIG. 1 depicts how the processing of analysis is carried out. In brief, as shown in FIG. 1, the machine learning functionality of the UPM assisted staffing platform receives candidate hard skill information inputs from online candidate assessments, performance data, data analysis, and a suite of predictive algorithms. The UPM is both global and client specific, a key advantage of the present technology resulting from the application of machine learning to data collection and analysis. Notably, machine learning is applied to uncover attributes that are otherwise hidden to staffing suppliers such as the intersection of hard skill information and cognitive ability in a given workplace setting. In some embodiments, data is collected and collated through methods commonly known in the art.

In some embodiments, hard information such as market rates are identified and analyzed algorithmically and/or by human analysts for all positions. Machine learning is then applied to such analysis in order to uncover hidden attributes. As described soft skills are identified by completing online assessment surveys and by playing games. In some embodiments, these surveys and games also use machine learning to identify neural assessments of the candidate's brain or traits.

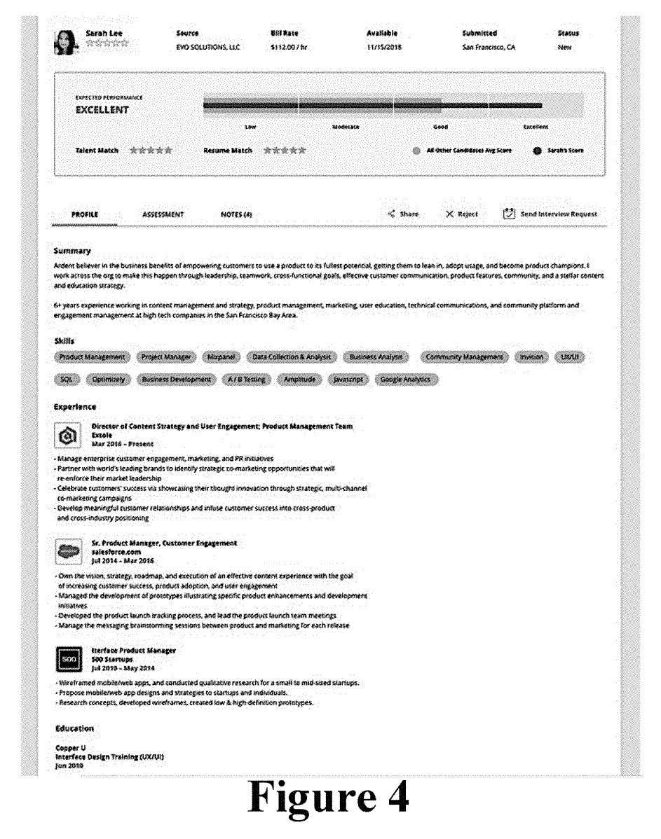

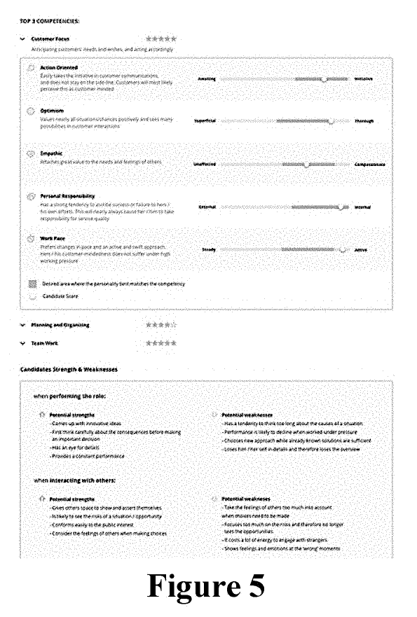

Referring to FIG. 4, hard skill candidate information may comprise candidate summary information, skills summary information, and detailed experience information. As shown in FIG. 4, in some embodiments, detailed experience information may comprise a display of position title, position duration, bulleted experience descriptions, education experience, and the like. As shown in FIG. 5, in some embodiments, hard skill competency summary information may be listed in tandem with soft skill information

In some embodiments, hard skill candidate information may comprise resume information. Resume information may comprise job titles for each of one or more jobs previously held by the candidate, duration of previous posts, subject qualifications obtained by the candidate, job title of the most recent job held by candidate, and the like. Hard skill information may also relate to experience information, including whether the candidate has previously held a comparable management position, highest educational level attained by the candidate, and the like. Finally, hard skill information may include alternate hard skill information, such as the number of commonly misspelled words in the candidate's resume, the number of grammatical errors in a candidate email, the number of timely follow-ups to emails, and the like. Other features, drawn from external data, may include ranking of school attended, criminal record, periodical information, and the like. Notably, hard skills may be accompanied by other hard information such as candidate identification number that merely serves an internal reference purpose and is not necessarily derived from intrinsically meaningful candidate information.

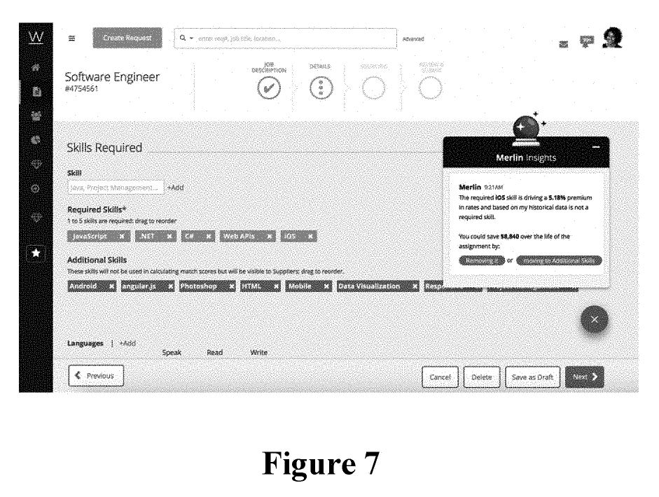

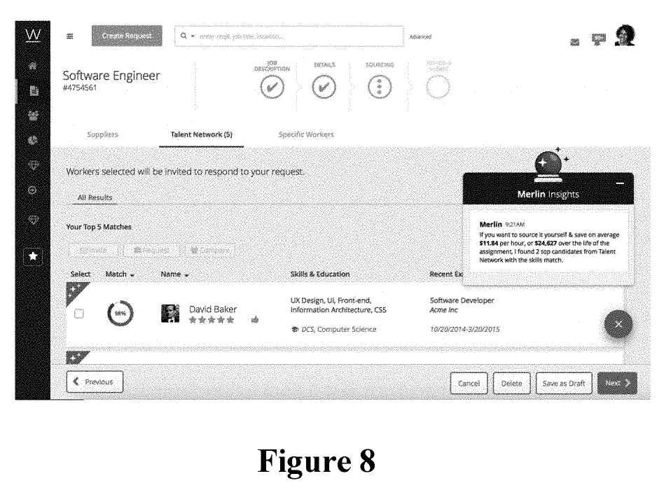

Referring to FIG. 7, in some embodiments the UPM assisted staffing platform may reference a skills page containing hard skill information in order to recommend a candidate. The UPM algorithm utilizes job requisition information containing hard skills and other hard information including candidate identification number, job description, current Required Skills, and Additional skills. As shown in FIG. 7, the Software Engineer position requires 5 skills including JavaScript, .Net, C#, Web APIs and iOS. As shown in FIG. 8, the machine learning module may utilize recent experience information including the duration of the recent experiences. As shown in FIG. 8, the machine learning module may also utilize a rating system built into the platform, a matching percentage, a profile picture, and various other candidate hard skill information. By comparing the required skill information, additional skill information, and other candidate information, the machine learning module is able to recommend a particular candidate to fill the software engineer position in the most cost-effective manner.

II. Compensation

The UPM assisted staffing platform may identify and recommend candidates based on compensation and/or billing rate information. As described above, billing rates and compensation can be matched algorithmically to job requirements, but the current disclosure further provides for a means of matching billing rates machine learning, artificial intelligence, and embedded intelligence in order to further enhance the accuracy and precision of the staffing sourcing program.

In some embodiments, billing rate information relates to skills and experience that are absolutely required for a given position and are therefore subject to little flexibility. Notably, billing rate information may derive from historical data and relationships such as prior job titles, employers, income, schools attended, subject matter area(s) of study, managerial qualifications, and other information commonly mined in resume databases. By comparing the billing rate information, additional skill information, and other candidate information, the UPM assisted staffing platform is able to analyze candidate data and recommend a particular candidate to fill the software engineer position in the most cost-effective manner. The machine learning module may carry out this analysis using decision logic stored on the computer, or by other standard methods well known in the art.

III. Soft Skills

Soft skills may be identified using machine learning to identify neural assessment of the brain of the candidates, that is, traits. Using machine learning, the system may identify personality and cognitive abilities through the implementation of adaptive personality surveys and games. Adaptive in one embodiment may mean that survey questions will change depending on the answer. For example, games may become easier or harder based on the ability of the candidate. In some embodiments, the games involve and measure logical reasoning and problem-solving ability, risk taking ability, task switching ability, impulse control and response inhibition.

FIG. 1 depicts how the processing of game and survey analysis is carried out. In brief, as shown in FIG. 1, the machine learning functionality of the UPM assisted staffing platform receives soft skill information inputs from 1) online candidate assessments, 2) performance data, 3) data analysis, and a 4) predictive algorithms.

In the preferred embodiment, online candidate assessments comprise categorizing candidates through a variety of factors including candidate skill information. Candidate skill information comprises hard skill information, soft skill information, billing rates, compensation data, and extraneous data. in some embodiments, performance data includes identifying and analyzing candidates through an analysis of candidate skill information. Further, performance data includes identifying and analyzing performance on games, performance on surveys, objective metrics of past performance in the workplace, and the like. In some embodiments, data analysis includes application of algorithms, machine learning, embedded intelligence, and data-driven tools to the online candidate assessment data and performance data described above. In some embodiments, candidate analysis focuses on candidate assessment and or performance data. Predictive algorithms comprise further application of machine learning, embedded intelligence, and data-driven algorithms to the prediction of candidate performance in the workplace both in relation to hard skill information and soft skill information. In some embodiments, predictive algorithms are applied to candidate analysis information.

In the preferred embodiment, performance data, candidate skill information, survey performance data, and predictive algorithm data is collected and collated through methods commonly known in the art. The UPM is both global and client specific, a feature resulting from the application of machine learning to data collection and analysis. Notably, machine learning is applied to uncover attributes that are otherwise hidden to staffing suppliers such as personality fit in a given workplace.

In some embodiments, candidate skill information is identified and analyzed algorithmically and/or by human analysts for all positions. Machine learning is then applied to such analysis in order to uncover hidden attributes. As described candidate skill information is identified by completing online assessment surveys and by playing games. In some embodiments, these surveys and games also use machine learning to identify neural assessments of the candidate's brain or traits.

Referring to FIG. 5, displayed soft skill candidate information may include factors relating to whether a candidate is action-oriented, optimistic, empathetic, responsible, and/or adaptable in the workplace. As shown in FIG. 5, in some embodiments each of these metrics are accompanied by a rating scale ranging from a low score to a high score. In some embodiments, competencies are subdivided into customer focus, planning and organization, teamwork, and the like. As shown in FIG. 5, in other embodiments candidate strengths and weaknesses in relation to performing the role are summarized and subdivided into potential strengths and potential weaknesses. Further, candidate strengths and weaknesses in relation to interacting with others versus may be summarized in bulleted form.

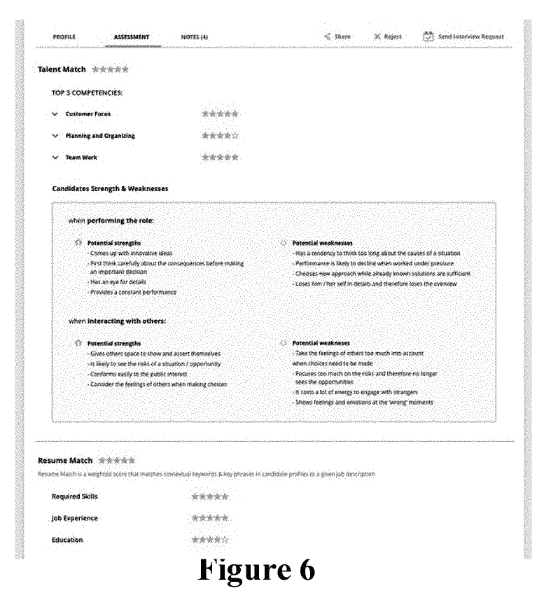

Referring to FIG. 6, accompanying candidate competency information and candidate strengths/weakness, a resume match conclusion section may be provided. As shown in FIG. 6, resume match conclusion information may comprise a weighted score pertaining to required skills, job experience, and education.

Expanding on soft skill information, soft skill information relates to factors such as personality, cognitive ability, and/or social skills. Soft skill information may derive from a variety of sources, including logical reasoning information. Logical reasoning information may include problem-solving ability information, risk taking ability information, task switching ability information, impulse control information and response inhibition information. secondary information from industry taxonomies; inverse document frequencies based upon in-house resume and job description corpuses; quantifying gaps in employment or frequency of job-hopping; whether an applicant is overqualified; previous versus current salary expectations; career trajectory; company prestige; whether an applicant previously worked for a competitor of the potential employer; certifications; school rank; education timeline; several different semantic relationships between the resume and job description; resume and job description spectral density; level of social activity (for example, number of first-level connections in a social network); company connections (for example, how many people in the candidate's social network work at the same company as listing the job opening); social network size; personality traits; cognitive profile; unique analysis of data from the Bureau of Labor and Statistics and many other available sources; SIC codes; SEO, etc. Thus, in addition to hard skills directly related to job description and resume, many additional external data sources are utilized to calculate soft skill information and extraneous information.

IV. Extraneous Skills

In the preferred embodiment, extraneous skills may comprise any information not directly required of a job applicant. In other words, an extraneous skill could constitute a hard skill if an employer indicated that a particular skill was required. Thus, the description above listing sources of hard skill information is also applicable to the extraneous skill category. For example, hard skills and extraneous skills may both derive from historical relationships such as prior employer, school attended, subject area of major, previous job titles, managerial qualifications, and other hard skill information listed above.

In some embodiments, extraneous skill candidate information may comprise job titles for each of one or more jobs previously held by the candidate, length of time the candidate held each of one or more previous jobs, subject matter of each of one or more qualifications obtained by the candidate, job title of the most recent job held by candidate, whether the candidate has previously held a comparable management position, highest educational level attained by the candidate, and the number of commonly misspelled words in the candidate's resume. Other features, drawn from external data, may include: ranking of school attended, criminal record, periodical information, and the like.

Staffing Platform

As described above, the present UPM assisted staffing platform comprises two interrelated components, the UPM program and the staffing platform. The staffing platform comprises an application providing users with automated job recruitment tools that integrate seamlessly with the UPM assistant described above. Below, the staffing platform of the present invention is disclosed in detail.

The staffing platform of the present invention provides users with a web-based and mobile-based application that enables users to process job applications and various other job recruitment information simultaneously. The staffing platform is compatible with a variety of operating systems including iOS, Android and other operating systems known in the art.

In the preferred embodiment, the staffing platform enables enrollment of users, enrollment of candidates, receiving new staffing requests from users via a new staffing request page, creating job requirements for users based on the information provided in the new staffing requests, receiving profiles from candidates, and finally matching the profiles with the job requirements. In some embodiments, the method for providing a staffing platform also includes providing an integrated interview scheduling feature, thereby allowing the candidates and the users to arrange interview times and/or locations. Interviewees are provided with potential interview time slots, and select their preferred time and location for the interview via the staffing platform.

In some embodiments, the staffing platform provides an integrated calling and chatting feature, allowing the candidates and the users to connect. In other embodiments, the staffing platform provides an expense management feature based on candidate and staffing supplier expenses. Hiring entities and/or staffing suppliers utilize the staffing platform to approve of or deny said expenses. In yet another embodiment, the staffing platform tracks various candidate activities and user activities, providing updates to the candidates and the users, based on said tracking. Candidate activities may include changes to prior employer history, phone call logs, email logs, etc. User activities may include the frequency of external supplier use, the number of UPM assisted recommendations accepted by a user, and the like.

Notably, as in the case of the UPM assisted embodiments described above, the staffing sourcing component of the virtually assisted staffing platform also contemplates a web-based application for staffing suppliers. Further, in the preferred embodiment, the staffing platform is capable of providing real-time notifications to users regarding job management information without the need to log in to the application itself. In other words, notifications are visible from a user's mobile “lock screen” without the need for a user to unlock his or her phone. Job management information shown on the lock screen may comprise new staffing requests, interview scheduling, expense management, external supplier information, external supplier use, and UPM assisted recommendations.

As mentioned above, as an initial step, users must engage in account enrollment on a user account enrollment page in order to utilize the staffing platform system aspect of the present invention. In some embodiments, account enrollment for users may include the following: user identification information is inputted, user contact information is inputted, a unique Email ID is generated, a password is created, and the like. In some embodiments, the Email ID may be used for tracking the users and for other contextual aspects of the staffing platform system. In some embodiments, staffing suppliers may post jobs on a variety of external staffing platforms with this unique Email ID.

In addition, candidates must engage in account enrollment on a candidate account enrollment page in order to utilize the staffing platform system. In some embodiments, account enrollment for candidates may include the following steps: candidate identification information is inputted, a unique Email ID is generated, a password is created, and the like.

Regarding the new staffing request functionality of the staffing system aspect of the present invention, the staffing platform is capable of providing new staffing requests from users via a new staffing request page. The new staffing requests are transmitted and processed in real-time on both mobile and web-based devices. In some embodiments, the new staffing request page provides users with job requisition information. Job requisition information may include absolute requirements for a given position including, for example, a required number of years of managerial experience, educational degrees, professional licenses, and the like.

The new staffing request page may further comprise candidate profiles, hiring entity names, duration of the requested contract, hourly billable rates, the number of open positions, position titles, position locations, alternate potential employer locations, number of action items requiring the user's attention, selectable search icons, selectable search filter icons, selectable email icons, links to more details, and the like. The requisition details accessible from said screen may be forwarded via email and other messaging services common in the art. As described above, the staffing platform aspect of the present virtually assisted staffing platform invention comprises both a job requisition review feature and job requisition forwarding feature. The later feature allows users to forward job requisition details to other users in a secure manner. In further reference to the new staffing request functionality of the present invention, in other embodiments the ability to view and communicate with previously submitted candidates is available. In yet another embodiment of the new staffing request functionality, the ability to view pending and completed interviews is available.

Regarding the integrated interview scheduling feature of the staffing platform, the staffing platform is capable of providing real-time information regarding interview scheduling on a mobile or web-based device. In the preferred embodiment, the integrated interview scheduling feature allows users to send up to five potential interview time slots to candidates. In other embodiments, the integrated interview scheduling feature allows users to choose their own time slots for an interview in real-time. In addition, the integrated interview scheduling feature allows candidates to email, text, or SMS chat with staffing suppliers regarding the interview times and locations. In some embodiments, the interview scheduling feature allows candidates to choose their preferred interview times or locations via the staffing platform.

Further to the interview scheduling feature, once an interview time slot is chosen by a given candidate the user then receives the candidates preferred times and/or locations via an interview notification module. The interview notification module alerts users to the chosen interview time and date via text message, SMS chat, email, or via a interviewing scheduling page. In some embodiments, this interview notification information is shared with all three parties via a shared calendaring system. In some embodiments of the staffing platform, the integrated interview scheduling feature also includes a follow-up tool wherein candidates and users are able to arrange for a follow-up recruiter meeting time and location, if needed.

In some embodiments, interview scheduling functionality of the staffing platform may permit display of the number of potential interview times provided to a candidate, the interview category (comprising phone interviews, and/or in-person interviews, and/or group lunches, and the like), the number of open related positions, in addition to the name of the hiring entity. Further, the staffing platform may display the position title for the open position, the allocated budget, the interview time, the interview location, alternate position locations, the number of action items requiring the user's attention, selectable search icons, selectable search filter icons, selectable email icons, links to more details, and the like. In some embodiments, the application is capable of displaying real-time notifications regarding interview times and the like without the need to log in to the application.

Regarding the expense management feature of the present invention, the staffing platform displays real-time notifications regarding candidate and staffing supplier expenses on both mobile and web-based devices. The expense management feature comprises information regarding the expense category, the name of spender, payments executed, reference numbers, and the hiring entity or other entity responsible for covering the expenses. The expense category includes candidate expense information related to food and/or hotel and/or gas and/or flight and/or uncategorized expenses, and the like. In some embodiments, users can view receipts, and exchange copies of the receipts with interviewees during follow-up recruiter meetings, if necessary. In some embodiments, the application is capable of displaying real-time notifications on a user's mobile lock screen such as new expenses logged without the need to log in to the application.

As noted above, the present invention contemplates a calling and chatting feature relevant to all of the job recruitment features herein described, including new staffing requests, integrated interview scheduling, and expense management. In the preferred embodiment, the staffing system integrates SMS, email, and texting buttons into each display page, allowing the candidates and the users to connect instantly.

Regarding the supplier search and filter functionalities of the present invention, the staffing platform provides real-time data-driven tools for users to filter their action items. In some embodiments, the supplier and search filter functionalities permit users to select from a variety of functions including, but not limited to: select all, requests, interviews, and/or expenses. Further, in some embodiments, suppliers can search the application by name, requisition number, engagement number, and/or other filters commonly used in the art.

As described above, in some embodiments the present invention comprises an information processing system and/or staffing sourcing system in a job recruitment environment. In one embodiment, the herein disclosed methods for providing a UPM assisted staffing platform comprise: enrolling a user and/or staffing supplier and/or hiring entity, identifying external suppliers, matching users with information about external suppliers, identifying alternate employer locations, recommending alternate employer locations to users, and identifying extraneous skills of job applicants.

In further embodiments, the virtually assisted staffing platform comprises: a system comprising a server connected to a network, wherein the server receives requests from users via a network. This server may include a processor(s), a database for storing candidate information, and a memory operatively coupled to the processor. In some embodiments of the present invention, memory stores program instructions that when executed by the processor, causes the processor to receive new staffing requests from a user via the network. Logistical interview information is generated from the candidate database based on the new staffing request. Finally, the potential interview times and locations are transmitted to the user via the network.

Referring further to the staffing sourcing system described above, the candidate information database comprises a database of information comprising candidate availability, candidate hard skills, candidate soft skills, candidate billing rates, candidate geographical preferences, automated candidate recommendations, and the like. Logistical interview information comprises at least potential interview dates feasible for candidates, potential interview times feasible for candidates, geographical information, hotel preferences, and the like.

As described above, the present invention is an application capable of displaying real-time notifications to a mobile device and/or website. A mobile device may be a wireless mobile device or any type of portable computer device, including a cellular telephone, a Personal Digital Assistant (PDA), smartphone, etc. By way of example only, and not by way of limitation, smartphones contemplated by the present invention include Apple's iPhone series, Google's Droid and Nexus One series, Palm's Pre series, and RIM's Blackberry series of smartphones. In some embodiments, mobile devices comprise a camera, a processor, a graphical user interface (GUI), and a memory. In embodiments, the memory is operatively coupled to the processor and stores program instructions that when executed by the processor, causes the processor to receive an image from the camera. Said image may be displayed on the GUI. The GUI may also receive descriptive data for the image and store the descriptive data and image as a listing. Generally, said listing may be transmitted wirelessly to a host server. Further, the mobile device may comprise a display, a GPS module, a compass, a camera and various other input/output (I/O) components.

As described above, the present invention relates to information processing methods and systems comprising a virtually assisted staffing platform. Said system can take the form of an entirely hardware embodiment, an entirely software embodiment or an embodiment containing both hardware and software elements. In one embodiment, the system is implemented in software, which includes but is not limited to firmware, resident software, microcode, etc.

Furthermore, the system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet 20 can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as JAVA® applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive hypertext environment with regard to the present application.

A website is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Netscape's NAVIGATOR® or Microsoft's Internet Explorer, is a software application program for providing a user interface to the WWW. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plugins, that run specialized functionality within the browser.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A method for providing an assisted staffing platform for automated job management, the method comprising:
a. categorizing candidates with candidate assessments;
b. receiving performance data with candidate skill information;
c. analyzing candidate information from candidate assessments and/or performance data;
d. applying predictive algorithms to analyzed candidate information;
e. receiving new staffing requests from a user;
f. displaying basic candidate information, wherein basic candidate information comprises heading information and candidate tally information,
g. recommending one or more candidates to the users, wherein recommendations are based on analyzed candidate information and/or performance data;
h. tracking activities of the candidates and the users; and
i. providing updates to the candidates and the users, based on the tracking.

2. The method of claim 1, wherein the user comprises a staffing supplier and/or a hiring entity.

3. The method as claimed in claim 2, wherein the staffing supplier comprises a recruiter.

4. The method as claimed in claim 2, wherein the hiring entity comprises a hiring manager and/or administrator.

5. The method of claim 1, wherein candidate skill information further comprises resume information.

6. The method of claim 1, wherein candidate skill information further comprises experience information.

7. The method of claim 1, wherein candidate skill information further comprises billing rates and/or compensation information.

8. A method for providing an assisted staffing platform for automated job management, the method comprising:
a. receiving new staffing requests from a user, wherein a user comprises a staffing supplier and/or a hiring entity;
b. receiving profiles from candidates;
c. matching the profiles with the job requirements;
d. categorizing candidates with candidate assessments;
e. receiving performance data with candidate skill information, wherein candidate skill information comprises results of online assessment surveys and/or results of candidates playing games;
f. analyzing candidate information from candidate assessments and/or performance data;
g. applying predictive algorithms to analyzed candidate information;
h. recommending one or more candidates to the users, wherein recommendations are based on an analysis of candidate information; and
i. tracking activities of the candidates and the users.

9. The method of claim 8, wherein candidate skill information further comprises resume information.

10. The method of claim 9, wherein resume information comprises duration of previous posts.

11. The method of claim 9, wherein candidate resume information further comprises subject qualifications.
